(19) United States
(12) Patent Application Publication
(10) Pub. No.: US 2003/0019813 A1
(43) Pub. Date: Jan. 30, 2003

(54) Antimicrobial polymer foams with amino alcohols

(75) Inventors: Peter Ottersbach, Windeck (DE); Martina Inhester, Herten (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DE GUSSA AG, Duesseldorf (DE)

(21) Appl. No.: 10/183,503

(22) Filed: Jun. 28, 2002

(30) Foreign Application Priority Data
Jun. 29, 2001 (DE) 101 31 484.1

(51) Int. Cl. C08L 1/00; C08F 14/00; C08F 114/00; C08F 214/00; C08F 2/00; C02F 1/42; B01D 15/00; B01J 39/00; G21F 9/04

(52) U.S. Cl. 210/660; 521/134; 521/139; 521/146; 521/147; 210/681; 210/661

(57) ABSTRACT

The invention relates to antimicrobial foam materials with amino alcohols, their preparation, and their use.

### BACKGROUND OF INVENTION

1. Field of the Invention

The invention relates to antimicrobial foam materials comprising one or more foamed polymers and at least one amino alcohol, processes of making such antimicrobial materials, and processes of treating foamed materials with amino alcohols.

2. Discussion of the Background

The surfaces of pipelines, containers, and packaging are susceptible to undesirable colonization and propagation of bacteria. Coats of slime can form on these surfaces, which give rise to extremely high levels of microbial populations. This phenomenon can adversely affect the quality of water, beverages, and foods intended for human consumption because it causes these products to decay. Therefore, it may even damage the health of consumers.

Good hygiene is important for products intended for human consumption or intimate human contact, including the treatment, prevention, and reduction of bacterial growth on these products. These products may include textiles, especially those textiles intended for use near and around the genital area of individuals. Further, good hygiene is required for textiles required in the care of the sick and the elderly.

Good hygiene is required in and around hospitals. This includes hospital wards, areas for medical interventions, and toilets. Examples of hospital wards include but are not limited to intensive care, neonatal, and isolation wards. Isolation wards include those in which critical cases of infection are treated. There is a need for bacteria to be kept away from all surfaces, such as surfaces of furniture and instruments, in and around hospitals.

The surfaces of textiles, furniture, and instruments may be treated to prevent and reduce bacterial growth using chemicals or solutions thereof. Further, such chemicals and solutions may be used in mixtures as disinfectants. Such mixtures can possess high antimicrobial action for a broad range of microbes. However, these mixtures are nonspecific in their action, and thus are toxins or irritants. Frequently, these chemical mixtures break down to form degradation byproducts that are considered health risks if exposed to humans. Many individuals may be sensitized to these mixtures and their degradation byproducts if previously exposed. Therefore, such individuals are incompatible with the use of such mixtures, and further may be incompatible with the surfaces of textiles, furniture, and instruments that may be pretreated with such mixtures to prevent and reduce bacterial growth.

Algae prevalently grow on surfaces as well. Therefore, a constant challenge is to find methods to treat, prevent, and reduce algal growth on surfaces. Such surfaces include external surfaces of buildings, especially buildings with plastic cladding. Algal growth and colonization on such surfaces leads to undesirable appearances at surfaces. Further, it may lead to the improper function of structural components having surfaces colonized with algae. One example of a structural component whose function is negatively impacted by algal colonization is those having a photovoltaic function.

Fungi may infest surfaces, yet there exists no technically acceptable solution to treat, prevent, or reduce such microbial contamination. Fungi may infest internal and external surfaces that are wet, such as wet joints and walls. Fungal infestation not only leads to undesirable appearances due, but also serious health risks. Fungal infestation pose the largest health risk to those individuals that may be allergic to fungi and/or their byproducts, leading to severe chronic respiratory disease. An example of one such fungus is Aspergillus niger.

Insulating materials are used on the exterior of surfaces used outdoors. Generally, insulating materials are foam substrates and materials. Further, upholstery materials may possess a large amount of foam substrates and materials. Examples of such upholstery materials include but is not limited to automobile seats, mattresses, and cushions. Foam substrates and material have very large surface areas, rendering them very susceptible to microbial attack. Further, foam substrates and materials are also very susceptible to microbial attack because of their porous structure. Microbial colonization of such substrates and materials occur very often in the presence of moisture, and may lead to the devastation of such substrates and materials if exposed to these conditions for a number of hours each day. An example of one foam substrate is a mattress. As a result there is a need for methods of treating, preventing, and reducing microbial infestation, while eliminating side effects that may originate from low molecular mass biocides.

Partial microbial infestation of foam substrates and materials may also lead to deleterious effects. Filter systems made from foam materials can act as breeding grounds for microbes such as molds. Examples of such filter systems include pollen filters as part of air cleaning modules. Contaminated filter systems may release high doses of poisonous toxins and spores for a prolonged period of time. Because such systems are being used in large part by the automobile industry, this problem is increasing, especially when used in proximity to individuals capable of acquiring harmful allergies and severe diseases. Most often these individuals have high sensitivity to the microbes or impaired health.

Microbial infestation of surfaces of marine vessels is also undesirable. For example, microbial infestation of marine hulls may lead to increased flow resistance of ships, and therefore, increased fuel consumption. As a result, microbial infestation at the surfaces of marine vessels has a negative economic impact on the shipping industry. Such infestation can be treated with antifouling coatings, which possess toxic heavy metals or low molecular mass biocides. Therefore, the harmful side effects of such coatings are tolerated in order to decrease the negative economic impact of such microbial infestations. However, the growing awareness of their impact to the environment has produced a social desire to eliminate coatings with toxic heavy metals or low molecular mass biocides from being used as antimicrobial agents on marine vessels.

The surfaces of textiles, furniture, and instruments may be treated to prevent and reduce bacterial growth using antimicrobial substances in matrices. U.S. Pat. No. 4,532,269 describes a terpolymer of butyl methacrylate, tributylin methacrylate, and tert-butylaminoethyl methacrylate. This copolymer is used in the marine industry as a coating to prevent microbial infestation. The tert-butylaminoethyl methacrylate is hydrophilic, which reduces erosion of the polymer and decreases the rate at which the highly toxic tributylin methacrylate is released to the environment. In many similar applications of copolymers, amino methacrylates merely act as a matrix or carrier for the microbial biocide to reside. The microbial biocide can diffuse out or migrate from the matrix or carrier material to a concentration level that is below the minimum inhibitory concentration (MIC) of microbial growth. Therefore, copolymers of this kind lose their antimicrobial activity at the surface on which they are applied.

European Patent application 0 862 858 describes copolymers of tert-butylaminoethyl methacrylate, a methacrylic ester with a secondary amino function. Such copolymers possess microbial biocide properties. This terpolymer has been found to possess “contact microbial biocide” properties in the absence of an additional microbial biocide. A “contact microbial biocide” is any polymer the does not include any low molecular mass constituents. Therefore, the antimicrobial property of a “contact microbial biocide” is derived from the contact between the bacteria and the surface of the polymer. The following patent applications describe a large number of “contact microbial biocide” polymers that are known: DE 100 24 270, DE 100 22 406, PCT/EP00/06501, DE 100 14 726, DE 100 08 177, PCT/EP00/06812, PCT/EP00/06487, PCT/EP00/06506, PCT/EP00/02813, PCT/EP/02819, PCT/EP00/02818, PCT/EP00/02780, PCT/EP00/02781, PCT/EP00/02783, PCT/EP00/02782, PCT/EP00/02799, PCT/EP00/02798, PCT/EP00/00545, and PCT/EP00/00544. Further, DE 10105 230.3 describes a method of producing an antimicrobial surface by covering polymer substrates such as polyamides or polyacrylates with amino alcohols.

Finally, research has shown that microbes are developing resistance to antimicrobial treatments as they adapt to overcome antibiotics. Therefore, it will be necessary to develop systems based on new classes of compositions having improved antimicrobial efficacy.

### SUMMARY OF THE INVENTION

One object of the present invention is a foamed substrate which is treated antimicrobially without the addition of low molecular mass biocides.

Another object of the present invention is to provide a processes for producing antimicrobial foam materials.

Another object of the present invention an antimicrobial foam material, comprising

at least one foamed polymer; and

at least amino alcohol of the formula I:

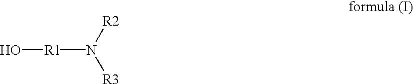

where

R1=branched or unbranched aliphatic or aromatic hydrocarbon radical having from 1 to 15 carbon atoms;

R2=H, branched or unbranched aliphatic or aromatic hydrocarbon radical having from 1 to 15 carbon atoms; and

R3=H, branched or unbranched aliphatic or aromatic hydrocarbon radical having from 1 to 15 carbon atoms.

Another object of the present invention is a process for producing an antimicrobial foam material, comprising

introducing at least one amino alcohol of the formula I:

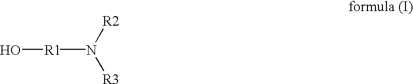

where

R1=branched or unbranched aliphatic or aromatic hydrocarbon radical having from 1 to 15 carbon atoms;

R2=H, branched or unbranched aliphatic or aromatic hydrocarbon radical having from 1 to 15 carbon atoms; and

R3=H, branched or unbranched aliphatic or aromatic hydrocarbon radical having from 1 to 15 carbon atoms

into a monomer mixture,

polymerizing this mixture, and

subsequently or simultaneously foaming the mixture.

Another object of the present invention is a process for antimicrobial treating a foam material, comprising

reacting, impregnating, or contacting the foam material with at least one amino alcohol of the formula I:

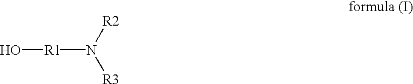

where

R1=branched or unbranched aliphatic or aromatic hydrocarbon radical having from 1 to 15 carbon atoms;

R2=H, branched or unbranched aliphatic or aromatic hydrocarbon radical having from 1 to 15 carbon atoms; and

R3=H, branched or unbranched aliphatic or aromatic hydrocarbon radical having from 1 to 15 carbon atoms.

Another object of the present invention is a process for producing an antimicrobial foam material, comprising

admixing at least one polymer with at least one amino alcohol of the formula I:

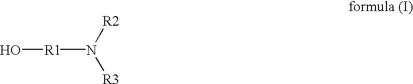

where

R1=branched or unbranched aliphatic or aromatic hydrocarbon radical having from 1 to 15 carbon atoms;

R2=H, branched or unbranched aliphatic or aromatic hydrocarbon radical having from 1 to 15 carbon atoms; and

R3=H, branched or unbranched aliphatic or aromatic hydrocarbon radical having from 1 to 15 carbon atoms

and foaming the mixture preferably using an inert gas.

Another object of the present invention is a process for sterilizing water, comprising adding an antimicrobial foam material, comprising

at least one foamed polymer; and

at least amino alcohol of the formula I:

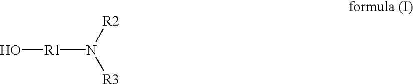

where

R1=branched or unbranched aliphatic or aromatic hydrocarbon radical having from 1 to 15 carbon atoms;

R2=H, branched or unbranched aliphatic or aromatic hydrocarbon radical having from 1 to 15 carbon atoms; and

R3=H, branched or unbranched aliphatic or aromatic hydrocarbon radical having from 1 to 15 carbon atoms.

to water in need of sterilization, or contacting such water with the foam material.

### DETAILED DESCRIPTION OF THE PRESENT INVENTION

Unless specifically defined, all technical and scientific terms used herein have the same meaning as commonly understood by a skilled artisan in biochemistry, chemistry, and materials science.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting.

In view of the above, a need exists to find new antimicrobial compositions with improved efficacy and reduced cost when processed with appropriate substrates. In further view of the development of microbial resistance to antibiotics, it is desirable to find effective countermeasures to microbial adaptations. It has been found that amino alcohols are suitable for the antimicrobial treatment of surfaces.

Such surfaces include foamed articles, substrates, and materials. The surfaces of foamed articles, substrates, and materials may carry antimicrobial polymers. These polymers are often processed together with plastics in order to strengthen the resistance of foamed articles, substrates, and materials to microbial attack. This may render foamed articles, substrates, and materials entirely inert to microbial attack at a competitive cost,

The present invention provides antimicrobial foam materials comprising one or more foamed polymers and also at least one amino alcohol of the formula I:

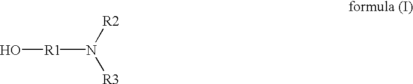

where

R1=branched or unbranched aliphatic or aromatic hydrocarbon radical having from 1 to 15 carbon atoms;

R2=H, branched or unbranched aliphatic or aromatic hydrocarbon radical having from 1 to 15 carbon atoms; and

R3=H, branched or unbranched aliphatic or aromatic hydrocarbon radical having from 1 to 15 carbon atoms.

The product of the invention is a foamed article such as a substrate that is treated antimicrobially, preferably without the addition of low molecular mass biocides. The action of the antimicrobial polymers described is derived from the contact of microorganisms with the surface of the polymer. Moreover, the availability of a large porous surface area of the foam article, substrate or material gives rise to increased antimicrobial action. As a result, efficient air cleaning systems may be created by using the foam articles, substrates, and materials of the present invention therein. Moreover, liquid-based flow systems may be revitalized by using the foam articles, substrates, and materials therein.

The foam articles, substrates, and materials of the present invention may also be processed into any product that can incorporate unmodified foamed articles, substrates, and materials. Some example products may include filter mats, insulating mats and materials, packaging materials, carpet backings, mattresses, seats, cushions, upholstery coverings, and air conditioning units.

The invention also relates to processes for producing antimicrobial foam articles, substrates, and materials. One process includes the introduction of the amino alcohols of formula I into a monomer mixture which is polymerized. The mixture can be subsequently or simultaneously foamed. Another process includes the introduction of the amino alcohols of formula I into a polymer mixture or polymer solution which is subsequently or simultaneously foamed, for example using an inert gas. A further process includes reacting the amino alcohol of formula I with a pre-produced, antimicrobial or non-antimicrobial foam material.

The foamed or unfoamed polymers, or the monomer mixtures, used in the above-described processes are not limited and may have the following compositions or properties:

monomers or foamed polymers may contain functional groups such as hydroxyl, carboxylic acid, sulfonic acid, amino, ester, ether, and amide groups;

one or more free-radical polymerizable olefinically unsaturated monomers;

preferred free-radical polymerizable monomers are vinyl derivatives, styrene compounds, allyl derivatives, olefins, acrylic and methacrylic acid compounds, methyl methacrylate, methyl acrylate, tert-butyl methacrylate, tert-butyl acrylate, butyl methacrylate, butyl acrylate, ethyl butyl methacrylate, ethyl butyl acrylate, propyl butyl methacrylate, butyl acrylate, isopropyl butyl methacrylate, and isopropyl butyl acrylate;

one or more polycondensable monomers; and

preferred polycondensable monomers are diols, diisocynates, diacids, and epoxides.

Preferred amino alcohols of the formula I are tert-butylaminoethanol, tert-butylaminomethanol, tert-butylaminopropanol, 2-butylaminoethanol, 2-butylaminomethanol, 2-butylaminopropanol, 2-diethylaminoethanol, 2-diethylaminomethanol, 2-diethylaminopropanol, 2-dimethylaminoethanol, 2-dimethylaminomethanol, 2-dimethylaminopropanol, aminoethanol, aminomethanol, aminopropanol, and aminobutanol.

The foamed or unfomed polymers preferably have a weight-average molecular weight of from 5,000 to 5,000,000 g, more preferably from 20,000 to 2,000,000. The ranges for the weight-average molecular weight of the foamed or unfoamed polymer include all specific values and subranges therebetween such as 10,000, 20,000, 50,000, 75,000, 100,000, 200,000, 300,000, 400,000, 500,000, 600,000, 700,000, 800,000, 900,000, 1,000,000, 2,000,000, 3,000,000 and 4,000,000. The amino alcohol of formula I may be part of a solution. One such solution may comprise an organic solvent. An example of an organic solvent that may be used in the solution is ethanol. The solution comprising the amino alcohol of formula I may be applied to the foamed substrate or material. For example, the foamed article may be immersed in a solution comprising the amino alcohol of formula I. Alternatively, the solution comprising the amino alcohol of formula I may be brushed or sprayed onto the foamed substrate or material.

The application of the amino alcohol of formula I to the foamed substrate or material may or may not be carried out further by a subsequent or simultaneous application of thermal energy. The amino alcohol is believed to attach to the surface of the foamed substrate, where it is thought to be bound physically by physiosorption. This is greatly favored by the large porous surface area of foamed articles, substrates, and materials because the efficiency of physiosorption increases as the surface area of the substrate increases.

The amino alcohol may be chemically attached to the surface of the foamed article, substrate, or material by reaction with suitable functional groups of the foamed article, substrate, or material. Suitable chemical coupling reactions include all types of reaction in organic chemistry involving the formation of chemical compounds, such as esterification or etherification, all within the skill of the ordinary artisan in view of this disclosure.

Application of the amino alcohol of formula I onto the foamed article, substrate, or material is preferably induced by heating to 20 to 200° C. either traditionally or with radiation. The ranges for the temperature include all specific values and subranges therebetween, such as 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, and 195° C. It is possible to activate the foam article, substrate, or material prior to application of the amino alcohols by plasma techniques, reaction with mineral acids or strong acids, electromagnetic radiation, especially UV radiation, flaming, or corona treatment, all within the skill of the artisan in view of this disclosure.

The antimicrobially-treated foamed article, substrate, or material preferably contains from 0.1 to 75% by weight of at least one amino alcohol of formula I, based on the total weight of the article. The ranges for the amount of the amino alcohol in the article, substrate, or material include all specific values and subranges therebetween, such as 0.5, 1, 1.5, 2, 2.5, 3 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, and 74.5 weight percent based on the total weight of the foamed article, substrate, or material.

In one preferred embodiment, one or more polymers may be admixed with at least one amino alcohol of the formula I:

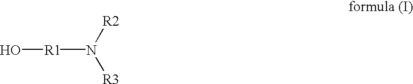

where

R1=branched or unbranched aliphatic or aromatic hydrocarbon radical having from 1 to 15 carbon atoms;

R2=H, branched or unbranched aliphatic or aromatic hydrocarbon radical having from 1 to 15 carbon atoms; and

R3=H, branched or unbranched aliphatic or aromatic hydrocarbon radical having from 1 to 15 carbon atoms.

and the mixture is foamed using an inert gas. The amino alcohols are preferably added to a solution or a melt of the polymers. Examples of solvents that can be used as inert liquids such as n-pentane, which bring about foaming of the polymer by evaporation. Further, a reaction solution containing at least one monomer form, from which the subsequent foam material is to be produced, can be admixed with an amino alcohol. Subsequently or simultaneously with the foaming process, the amino alcohol reacts with the polymer. This reaction can be initiated by supplying heat. Further, the reaction can be initiated by adding low-boiling organic substances, such as pentane and other organic solvents. Still further, the reaction can be initiated by adding chemically inert gases, such as nitrogen or carbon dioxide.

It is thought that the amino alcohol is either built into the polymer network as it forms or is fixed by way of its hydroxyl or amino function onto the polymer network of the foam article, substrate, or material. Suitable coupling reactions include all types of reaction in organic chemistry that involve the formation of chemical compounds, such as esterification or etherification. Further, the amino alcohols may be physically coupled to the large surface area of the foam article, substrate, or material, such as through physiosorption.

Antimicrobial foams provided by the processes above can be used to produce antimicrobial compounds. Examples of such antimicrobial compounds include but is not restricted to polyisoprenes, polydienes, polyamides, polyurethanes, polystyrenes, polyether-block-amides, polyesteramides, polyesterimides, PVC, polyolefins, silicones, polysiloxanes, polymethacrylate or polyterephthalates, metals, glasses, woods, and ceramics which are coated with compounds or polymer formulations of the invention.

Antimicrobial products made from the compounds of this kind are filter mats, insulating mats and materials, packaging materials, carpet backings, mattresses, seat and upholstery coverings, and components of air conditioning units. However, the products of the present invention are not limited to the above products because the above antimicrobial compounds may be used wherever bacteria-free, algae-free, fungus-free, and microbe-free surfaces are important. Further, they may be used wherever surfaces having anti-adhesion properties are desired.

The foam materials of the present invention may be used as biofouling inhibitors for water. For example, they may be used in cooling circuits. To prevent damage to cooling circuits as a result of algal or bacterial infestation, these cooling circuits must be cleaned at frequent intervals and/or constructed with a corresponding oversize. In open cooling systems such as those commonly used in power stations or chemical plants, the addition of antimicrobial substances such as formalin is not possible. Formalin and other antimicrobial substances are highly corrosive or foaming, which prevents their use in such systems. In contrast, it is possible to feed foam materials of the present invention, or their blends with further polymers, in comminuted form into the water of the utility. The resultant antimicrobial product has a highly active surface area. Therefore, the bacteria are readily killed and can be readily removed from the system by filtration. Accordingly, the deposition of bacteria or algae on components of power plants and chemical plants can be effectively prevented.

The antimicrobial foam materials of the present invention may also be used in processes of sterilizing water, especially streams of coolant water. The antimicrobial foam materials may be added to the water to be sterilized. The foam materials are preferably added in dispersion in water, or in comminuted form.

A comminuted form of the foam materials of the present invention may be obtained by means of previously known physical processes, such as mechanical cutting or thermal cutting. Foam materials of the present invention may be, e.g., are cut to sizes from 0.1 to 5.0 mm in spherical diameter. The ranges for the sizes of the cut foam materials include all specific values and subranges therebetween, such as 0.5, 1.0, 1.5, 2.0, 2.5, 3.0, 3.5, 4.0, and 4.5 mm in spherical diameter. This enables the foam material to be readily filtered from water while maintaining a large surface area that is optimal for killing the bacteria or algae. In this way, a method for sterilizing water is easy to implement, and a continuous sterilization process may be used as a result.

The continuous sterilization process may include removing from 5 to 10% of the foam products used in the system and replacing them by a corresponding amount of fresh material. Alternatively, the microbe count of the water can be continuously or sporadically monitored, and further antimicrobial foam materials may be added when and where necessary. A sufficient amount of antimicrobial foam materials for use in this process is generally from 0.1 to 100 g per 1 m³ of water, including all specific values and subranges therebetween, such as 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, and 99.5 per 1 m³.

The present invention is explained in more detail with the aid of the following embodiment examples. As can be seen from the following examples, the process according to the present invention can significantly reduce microbial infestation of the surfaces of porous materials.

### EXAMPLES

### Example 1

2 g of 2-tert-butylaminoethanol from Aldrich is dissolved in 10 mL of ethanol. A polyurethane foam disk with a thickness of 2 cm and a diameter of 4 cm is immersed in this mixture for 10 seconds. The treated foam is then dried at 35° C. for 8 hours.

### Example 1a

The coated foam disk from Example 1 is fixed on the bottom of a glass beaker containing 20 mL of a test microbe suspension of Pseudomonas aeruginosa. The system thus prepared is then shaken for 4 hours. After this time, 1 mL of the test microbe suspension is removed. The microbe count has now fallen from 10⁷ to 10² microbes per mL.

### Example 1b

The coated foam disk from Example 1 is fixed on the bottom of a glass beaker containing 20 mL of a test microbe suspension of Staphylococcus aureus. The system thus prepared is then shaken for 4 hours. After this time, 1 mL of the test microbe suspension is removed. Staphylococcus aureus microbes are no longer detectable.

### Example 1c

The coated foam disks from Example 1 are each inoculated with Chlorella sp., Trentepohlia sp., Gloeocapsa sp., Calothrix sp., or Aspergillis niger. These samples are then left in an incubator for 3 weeks. In contrast to control samples undergoing the same treatment, no infestation can be found on any of the coated foam disks.

### Example 2

0.2 g of 3-aminopropanol from Aldrich is dissolved in 10 mL of ethanol. A polyurethane foam disk with a thickness of 2 cm and a diameter of 4 cm is immersed in this mixture for 10 seconds. The treated foam is then dried at 35° C. for 8 hours.

### Example 2a

The coated foam disk from Example 2 is fixed on the bottom of a glass beaker containing 20 mL of a test microbe suspension of Pseudomonas aeruginosa. The system thus prepared is then shaken for 4 hours. After this time, 1 mL of the test microbe suspension is removed. The microbe count has now fallen from 10⁷ to 10² microbes per mL.

### Example 2b

The coated foam disk from Example 2 is fixed on the bottom of a glass beaker containing 20 mL of a test microbe suspension of Staphylococcus aureus. The system thus prepared is then shaken for 4 hours. After this time, 1 mL of the test microbe suspension is removed. Staphylococcus aureus microbes are no longer detectable.

### Example 2c

The coated foam disks from Example 2 are each inoculated with Chlorella sp., Trentepohlia sp., Gloeocapsa sp., Calothrix sp., or Aspergillis niger. These samples are then left in an incubator for 3 weeks. In contrast to control samples undergoing the same treatment, no infestation can be found on any of the coated foam disks.

### Example 3

2 g of 2-butylaminoethanol from Aldrich is dissolved in 10 mL of ethanol. A polyurethane foam disk with a thickness of 2 cm and a diameter of 4 cm is immersed in this mixture for 10 seconds. The treated foam is then dried at 35° C. for 8 hours.

### Example 3a

The coated foam disk from Example 3 is fixed on the bottom of a glass beaker containing 20 mL of a test microbe suspension of Pseudomonas aeruginosa. The system thus prepared is then shaken for 4 hours. After this time, 1 mL of the test microbe suspension is removed. The microbe count has now fallen from 10⁷ to 10² microbes per mL.

### Example 3b

The coated foam disk from Example 3 is fixed on the bottom of a glass beaker containing 20 mL of a test microbe suspension of Staphylococcus aureus. The system thus prepared is then shaken for 4 hours. After this time, 1 mL of the test microbe suspension is removed. Staphylococcus aureus microbes are no longer detectable.

### Example 3c

The coated foam disks from Example 3 are each inoculated with Chlorella sp., Trentepohlia sp., Gloeocapsa sp., Calothrix sp., or Aspergillis niger. These samples are then left in an incubator for 3 weeks. In contrast to control samples undergoing the same treatment, no infestation can be found on any of the coated foam disks.

### Example 4

0.2 g of 2-tert-butylaminoethanol from Aldrich and 2 g of polystyrene (from Aldrich) are dissolved in 10 mL of n-pentane. This mixture is placed in a 250 mL 3-necked flask which is subsequently heated to 80° C. During this process, the n-pentane boils and foams the resultant antimicrobial polystyrene. At the end of 2 hours, the flask is cooled to room temperature and the foamed product is removed.

### Example 4a

2 g of the product from Example 4 are placed in a tea strainer which is closed and placed in 20 mL of a test microbe suspension of Pseudomonas aeruginosa. The system thus prepared is then shake for 4 hours. After this time, 1 mL of the test microbe suspension is removed. The microbe count has now fallen from 10⁷ to 10² per mL.

### Example 4b

2 g of the product from Example 4 are placed in a tea strainer which is closed and placed in 20 mL of a test microbe suspension of Staphylococcus aureus. The system thus prepared is then shake for 4 hours. After this time, 1 mL of the test microbe suspension is removed. The microbe count has now fallen from 10⁷ to 10² per mL.

### Example 4c

2 g each of the product from Example 4 are placed in a tea strainer which is closed and placed in five different petri dishes. One each of these dishes is inoculated with Chlorella sp., Trentepohlia sp., Gloeocapsa sp., Calothrix sp., or Aspergillis niger. These samples are then left in an incubator for 3 weeks. In contrast to the control samples undergoing the same treatment, no infestation can be found on any of the sample sections.

### Example 5

0.2 g of 2-butylaminoethanol from Aldrich and 2 g of polystyrene (from Aldrich) are dissolved in 10 mL of n-pentane. This mixture is placed in a 250 mL 3-necked flask which is subsequently heated to 80° C. During this process, the n-pentane boils and foams the resultant antimicrobial polystyrene. At the end of 2 hours, the flask is cooled to room temperature and the foamed product is removed.

### Example 5a

2 g of the product from Example 5 are placed in a tea strainer which is closed and placed in 20 mL of a test microbe suspension of Pseudomonas aeruginosa. The system thus prepared is then shake for 4 hours. After this time, 1 mL of the test microbe suspension is removed. The microbe count has now fallen from 10⁷ to 10² per mL.

### Example 5b

2 g of the product from Example 5 are placed in a tea strainer which is closed and placed in 20 mL of a test microbe suspension of Staphylococcus aureus. The system thus prepared is then shake for 4 hours. After this time, 1 mL of the test microbe suspension is removed. The microbe count has now fallen from 10⁷ to 10² per mL.

### Example 5c

2 g each of the product from Example 5 are placed in a tea strainer which is closed and placed in five different petri dishes. One each of these dishes is inoculated with Chlorella sp., Trentepohlia sp., Gloeocapsa sp., Calothrix sp., or Aspergillis niger. These samples are then left in an incubator for 3 weeks. In contrast to the control samples undergoing the same treatment, no infestation can be found on any of the sample sections.

### Example 6

0.2 g of 3-aminopropanol from Aldrich and 2 g of polystyrene (from Aldrich) are dissolved in 10 mL of n-pentane. This mixture is placed in a 250 mL 3-necked flask which is subsequently heated to 80° C. During this process, the n-pentane boils and foams the resultant antimicrobial polystyrene. At the end of 2 hours, the flask is cooled to room temperature and the foamed product is removed.

### Example 6a

2 g of the product from Example 6 are placed in a tea strainer which is closed and placed in 20 mL of a test microbe suspension of Pseudomonas aeruginosa. The system thus prepared is then shake for 4 hours. After this time, 1 mL of the test microbe suspension is removed. The microbe count has now fallen from 10⁷ to 102 per mL.

### Example 6b

2 g of the product from Example 6 are placed in a tea strainer which is closed and placed in 20 mL of a test microbe suspension of Staphylococcus aureus. The system thus prepared is then shake for 4 hours. After this time, 1 mL of the test microbe suspension is removed. The microbe count has now fallen from 10⁷ to 10² per mL.

### Example 6c

2 g each of the product from Example 6 are placed in a tea strainer which is closed and placed in five different petri dishes. One each of these dishes is inoculated with Chlorella sp., Trentepohlia sp., Gloeocapsa sp., Calothrix sp., or Aspergillis niger. These samples are then left in an incubator for 3 weeks. In contrast to the control samples undergoing the same treatment, no infestation can be found on any of the sample sections.

The present application claims priority to German Application No. DE 101 31 484.1, filed on Jun. 29, 2001, which is hereby incorporated by reference in it entirety.

Numerous modifications and variations on the present invention are possible in light of the above teachings. It is, therefore, to be understood that within the scope of the accompanying claims, the invention may be practiced otherwise than as specifically described herein.

What is claimed is:

1. An antimicrobial foam material, comprising
at least one foamed polymer; and
at least amino alcohol of the formula I: 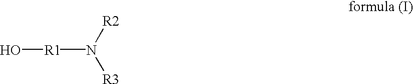
where
R1=branched or unbranched aliphatic or aromatic hydrocarbon radical having from 1 to 15 carbon atoms;
R2=H, branched or unbranched aliphatic or aromatic hydrocarbon radical having from 1 to 15 carbon atoms; and
R3=H, branched or unbranched aliphatic or aromatic hydrocarbon radical having from 1 to 15 carbon atoms.

2. The antimicrobial foam material according to claim 1, wherein the foamed polymer is foamed from a unsaturated olefinic monomer.

3. The antimicrobial foam material according to claim 2, wherein the olefinically saturated monomer is a free radically polymerizable, olefinically saturated monomer.

4. The antimicrobial foam material according to claim 2, wherein the olefinically unsaturated monomer is at least one member selected from the group consisting of a vinyl, styrene, allyl, olefin, acrylate , methacrylate, methyl methacrylate, methyl acrylate, tert-butyl methacrylate, tert-butyl acrylate, butyl methacrylate, butyl acrylate, ethyl methacrylate, ethyl acrylate, propyl methacrylate, ethyl acrylate, propyl methacrylate, isopropyl methacrylate, propyl acrylate, and isopropyl acrylate.

5. The antimicrobial foam material according to claim 1, wherein the foamed polymer comprises at least one functional group selected from the group consisting of a hydroxyl, carboxylic acid, sulfonic acid, amino, ester, ether, and amide.

6. The antimicrobial foam material according to claim 1, wherein the foamed polymer is prepared from a polycondensable monomer.

7. The antimicrobial foam material according to claim 6, wherein the polycondensable monomer at least one member selected from the group consisting of a diol, dilsocyanate, diacid, and epoxide.

8. The antimicrobial foam material according to claim 1, wherein the amino alcohol of formula I is selected from the group consisting of tert-butylaminoethanol, tert-butylaminomethanol, tert-butylaminopropanol, 2-butylaminoethanol, 2-butylaminomethanol, 2-butylaminopropanol, 2-diethylaminoethanol, 2-diethylaminomethanol, 2-diethylaminopropanol, 2-dimethylaminoethanol, 2-dimethylaminomethanol, 2-dimethylaminopropanol, aminoethanol, aminomethanol, aminopropanol, and aminobutanol.

9. The antimicrobial foam material according to claim 1, comprising from 0.1 to 75% by weight of the amino alcohol.

10. A process for sterilizing water, comprising
contacting water to be sterilized with the antimicrobial foam material according to claim 1.

11. An insulating material, upholstery, mattress, or filter mat, comprising the antimicrobial foam material of claim 1.

12. A process for producing an antimicrobial foam material, comprising
combining at least one amino alcohol of the formula I: 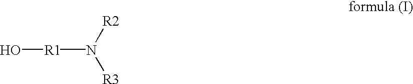
where
R1=branched or unbranched aliphatic or aromatic hydrocarbon radical having from 1 to 15 carbon atoms;
R2=H, branched or unbranched aliphatic or aromatic hydrocarbon radical having from 1 to 15 carbon atoms; and
R3=H, branched or unbranched aliphatic or aromatic hydrocarbon radical having from 1 to 15 carbon atoms
with a monomer to form a mixture,
polymerizing the mixture, and
subsequently or simultaneously foaming the mixture.

13. The process according to claim 12, wherein the monomer mixture comprises at least one unsaturated olefinic monomer.

14. The process according to claim 13, wherein the olefinically unsaturated monomer is free radically polymerizable.

15. The process according to claim 13, wherein the olefinically unsaturated monomer is selected from the group consisting of a vinyl, styrene, allyl, olefin, acrylate , methacrylate, methyl methacrylate, methyl acrylate, tert-butyl methacrylate, tert-butyl acrylate, butyl methacrylate, butyl acrylate, ethyl methacrylate, ethyl acrylate, propyl methacrylate, ethyl acrylate, propyl methacrylate, isopropyl methacrylate, propyl acrylate, and isopropyl acrylate.

16. The process according to claim 12, wherein the unsaturated olefinic monomer comprises at least one functional group selected from the group consisting of a hydroxyl, carboxylic acid, sulfonic acid, amino, ester, ether, and amide.

17. The process according to claim 12, wherein the monomer mixture comprises at least one polycondensable monomer.

18. The process according to claim 17, wherein the polycondensable monomer is selected from the group consisting of a diol, diisocyanate, diacid, and epoxide.

19. The process according to claim 12, wherein the amino alcohol of formula I is selected from the group consisting of tert-butylaminoethanol, tert-butylaminomethanol, tert-butylaminopropanol, 2-butylaminoethanol, 2-butylaminomethanol, 2-butylaminopropanol, 2-diethylaminoethanol, 2-diethylaminomethanol, 2-diethylaminopropanol, 2-dimethylaminoethanol, 2-dimethylaminomethanol, 2-dimethylaminopropanol, aminoethanol, aminomethanol, aminopropanol, and aminobutanol.

20. An antimicrobial foam material made by the process according to claim 12.

21. An antimicrobial foam material made by the process of claims 12, comprising from 0.1 to 75% by weight of the amino alcohol.

22. A process for treating a foam material, comprising
impregnating, reacting, or contacting the foam material with at least one amino alcohol of the formula I: 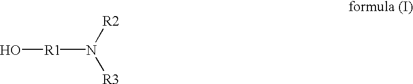
where
R1=branched or unbranched aliphatic or aromatic hydrocarbon radical having from 1 to 15 carbon atoms;
R2=H, branched or unbranched aliphatic or aromatic hydrocarbon radical having from 1 to 15 carbon atoms; and
R3=H, branched or unbranched aliphatic or aromatic hydrocarbon radical having from 1 to 15 carbon atoms.

23. The process according to claim 22, wherein the foam material is impregnated, reacted, or contacted with at least one amino alcohol in the presence of heat or radiation.

24. The process according to claim 23, wherein the wherein the foam material is impregnated, reacted, or contacted with at least one amino alcohol at a temperature of from 20 to 200° C.

25. The process according to claim 22, wherein the foam material is activated by at least one method selected from the group consisting of a plasma technique, mineral acid reaction, strong base reaction, electromagnetic radiation, UV radiation, flaming, and corona treatment.

26. The process according to claim 22, wherein the amino alcohol of formula I is selected from the group consisting of tert-butylaminoethanol, tert-butylaminomethanol, tert-butylaminopropanol, 2-butylaminoethanol, 2-butylaminomethanol, 2-butylaminopropanol, 2-diethylaminoethanol, 2-diethylaminomethanol, 2-diethylaminopropanol, 2-dimethylaminoethanol, 2-dimethylaminomethanol, 2-dimethylaminopropanol, aminoethanol, aminomethanol, aminopropanol, and aminobutanol.

27. An antimicrobial foam material made by the process according to claim 22.

28. An antimicrobial foam material made by the process according to claim 22, comprising from 0.1 to 75% by weight of the amino alcohol.

29. A process for producing an antimicrobial foam material, comprising
admixing at least one polymer with at least one amino alcohol of the formula I: 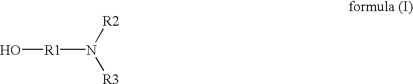
wherein
R1=branched or unbranched aliphatic or aromatic hydrocarbon radical having from 1 to 15 carbon atoms;
R2=H, branched or unbranched aliphatic or aromatic hydrocarbon radical having from 1 to 15 carbon atoms; and
R3=H, branched or unbranched aliphatic or aromatic hydrocarbon radical having from 1 to 15 carbon atoms
and foaming the mixture using an inert gas.

30. The process according to claim 29, wherein the amino alcohol is added to a solution or a melt of the polymer.

31. The process according to claim 29, wherein the polymer is dissolved in an inert liquid and foamed by evaporating the liquid.

32. The process according to claim 29, wherein the amino alcohols of formula I is selected from the group consisting of tert-butylaminoethanol, tert-butylaminomethanol, tert-butylaminopropanol, 2-butylaminoethanol, 2-butylaminomethanol, 2-butylaminopropanol, 2-diethylaminoethanol, 2-diethylaminomethanol, 2-diethylaminopropanol, 2-dimethylaminoethanol, 2-dimethylaminomethanol, 2-dimethylaminopropanol, aminoethanol, aminomethanol, aminopropanol, and aminobutanol.

33. The process according to claim 29, wherein the polymer is admixed with at least one amino alcohol in the presence of heat or radiation.

34. The process according to claim 33, wherein the polymer is admixed with at least one amino alcohol at a temperature of from 20 to 200° C.

35. An antimicrobial foam material made by the process according to claim 29.

36. An antimicrobial foam material made by the process according to claim 29, comprising from 0.1 to 75% by weight of the amino alcohol.
